(19) United States
(12) Patent Application Publication
(10) Pub. No.: US 2007/0226070 A1
(43) Pub. Date: Sep. 27, 2007

(54) Hybrid live and silent auction

(76) Inventor: Michael M. Murray, Greenwich, CT (US)

Correspondence Address: Michael M. Murray, 63 Birch Lane, Greenwich, CT, 06830, US

(21) Appl. No.: 11/389,830

(22) Filed: Mar. 27, 2006

(51) Int. Cl. G06Q 30/00

(52) U.S. Cl. 705/26

(57) ABSTRACT

A system and method for facilitating a hybrid live and silent auction for auctioning a plurality of items, comprising: a plurality of interactive display devices dispersed throughout an area where an auction will take place during a first period of time (silent auction), each of the interactive display devices being programmed to (i) display information concerning at least one of the plurality of items to be auctioned, (ii) to receive and store bid information input by a bidder related to the at least one item, and (iii) to transmit the bid information; and a central computer in communication with each of the interactive display devices and programmed to receive bid information transmitted by each of the interactive display devices. The bid information represents bids concerning the plurality of items, wherein the central computer is further programmed to select certain of the items for inclusion in a live auction to occur in a second period of time, the selecting being based on the bid information received from the interactive display devices. A display may be coupled to the central computer, the central computer being further programmed to display information concerning the selected items to an auctioneer to facilitate a live auction of the selected items during the second period of time.

### BACKGROUND

Auctions are a popular way to dispose of goods and services at a favorable price, and are frequently used to raise money for charities. One popular type of auction is known as a “silent auction” where items for auction are typically distributed throughout an area where potential bidders are free to roam about and view the items. Note that “items” as used herein is intended to include both actual items being auctioned (e.g., a piece of jewelry) as well as information identifying the actual item being auctioned (e.g., a description of a vacation package).

In a typical silent auction if a bidder wants to make a bid on an item, he or she will write his or her name or other identifying information (e.g., a pre-assigned bidder number) on a piece of paper placed near the item, along with the bid amount. Subsequent potential bidders can then see the current bids and can decide whether or not to place a higher bid. A higher bid can be written beneath the previous high bid. Such silent auctions typically end or close at a predetermined period of time (e.g., 11:00 p.m.) and the winner of each item is the person who has entered the highest bid at the time the auction closes.

A more traditional auction involves an auctioneer who presents each item to the bidding crowd and solicits bids on each item. Rather than ending at a fixed time, such auctions will usually continue for each item until, in the judgment of the auctioneer, no higher bids can be successfully solicited from the crowd. For this reason, live auctions tend to produce higher final prices than silent auctions. In other words, in a silent auction, there may have been a potentially higher bidder who was not able to place his or her bid before the auction closed. In a live auction environment, all bidders have an opportunity to be present and to participate as each item closes.

### SUMMARY OF THE INVENTION

In one aspect, the invention features a system for facilitating a hybrid live and silent auction for auctioning a plurality of items, comprising: a plurality of interactive display devices dispersed throughout an area where an auction will take place during a first period of time, each of the interactive display devices being programmed to (i) display information concerning at least one of the plurality of items to be auctioned, (ii) to receive and store bid information input by a bidder related to the at least one item, and (iii) to transmit the bid information; and a central computer in communication with each of the interactive display devices and programmed to receive bid information transmitted by each of the interactive display devices, the bid information representing bids concerning the plurality of items, wherein the central computer is further programmed to select certain of the items for inclusion in a live auction to occur in a second period of time, the selecting being based on the bid information received from the interactive display devices; and a display coupled to the central computer, the central computer being further programmed to display information concerning the selected items to an auctioneer to facilitate a live auction of the selected items during the second period of time.

In another aspect, the invention features a method for conducting a hybrid live and silent auction for auctioning a plurality of items, comprising the steps of: presenting the items to potential bidders during a first period of time; recording information concerning bids made on the items by the bidders during the first period of time; selecting certain of the items for inclusion in a live auction to occur in a second period of time, the selecting being based on the information recorded during the recording step; and presenting the items selected during the selecting step to the bidders in a live auction during the second period of time.

In certain embodiments, the second period of time follows the first period of time. Alternatively, the second period of time can at least partially overlap the first period of time. As another alternative, the first period of time and the second period of time are concurrent. The selected items preferably constitute less than all of the items for auction.

The presenting and recording steps described above may be performed using a computer. In certain embodiments, those items that are not selected during the selecting step are deemed sold to a highest bidder recorded during the first period of time. The selecting step may comprise selecting those items that have had at least a predetermined number of bids. Alternatively, the selecting step may comprise selecting those items that have had at least a predetermined number of bids within a predetermined portion of the first period of time. The predetermined portion of the first period of time may be at the end of the first period of time.

In certain embodiments, the live auction begins for each selected item with the highest bid recorded during the first period of time.

In another aspect, the invention features a system for facilitating a hybrid live and silent auction for auctioning a plurality of items, comprising: a plurality of interactive display devices dispersed throughout an area where an auction will take place during a first period of time, each of the interactive display devices being programmed to (i) display information concerning at least one of the plurality of items to be auctioned, (ii) to receive and store bid information input by a bidder related to the at least one item, and (iii) to transmit the bid information; and a central computer in communication with each of the interactive display devices and programmed to receive bid information transmitted by each of the interactive display devices, the bid information representing bids concerning the plurality of items, wherein the central computer is further programmed to select certain of the items for inclusion in a live auction to occur in a second period of time, the selecting being based on the bid information received from the interactive display devices.

The central computer may be further programmed to display information concerning the selected items to an auctioneer to facilitate a live auction of the selected items during the second period of time, the information including the highest bid recorded during the first period of time. The interactive display devices may each be programmed to display information concerning a plurality of items to be auctioned.

### BRIEF DESCRIPTION OF THE DRAWING

FIG. 1 is a block diagram of one system in accordance with one embodiment of the invention.

### DETAILED DESCRIPTION OF ILLUSTRATIVE EMBODIMENTS

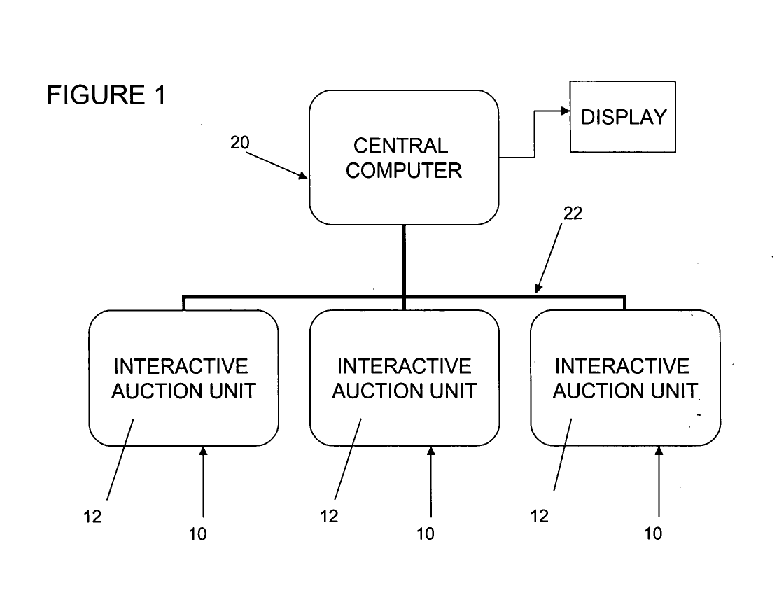

Referring to FIG. 1, a system is shown that can be used with one embodiment of the invention. A plurality of auction units 10 are shown, each with a touch-screen display area 12. Auctions units 10 can be, e.g., standard tablet computers available on the market (e.g., Fujitsu® Stylistic ST4000 running Windows® XP Tablet PC edition). Additional software to carry out the functions discussed herein would be provided and loaded onto the auction units 10 as would be well understood by those skilled in the art. Three such units are shown in FIG. 1, but the actual number used will depend on the size of the expected crowd and/or the number of items to be auctioned. For example, one auction unit 10 might be used for each item to be auctioned. Thus, potentially hundreds of such units might be utilized at a given auction.

The auction units can be distributed throughout the space where the auction is to occur. A prospective bidder may approach an auction unit and view information about an item for auction on display 12. If appropriate, the item itself may be located near the auction unit 10. The information about the item can be displayed using multiple screens that the user can navigate using a finger, stylus, keyboard or mouse as is well understood to those skilled in the art. For example, if the item is a vacation package, then pictures and/or video about the location and accommodations, etc. can be shown. If the user decides to place a bid, he or she can similarly enter the required information, including bidder identification and bid amount, into unit 10. Thereafter, the highest bid amount can be displayed to subsequent potential bidders.

One advantage to using such auction units 10 instead of traditional pieces of paper used at common silent auction events is that the name or other identifying information of the bidders need not be displayed to other potential bidders, allowing bidders to bid anonymously. Further, even the amount need not be shown, such that all potential bidders are bidding “blind.” Blind bids can occasionally achieve superior results as one bidder who particularly wants the item may enter a high bid in an effort to make sure that he or she beats all other bidders.

Either during the silent auction phase, or afterwards, information about the bids that have been placed is sent to a central computer 20 for analysis as described below. Central computer 20 is in communication with the auction units 10 during this transmission process in any one of several well-understood ways. For example, through a wired or wireless network, through an Internet connection, etc. Item 22 in FIG. 1 illustrates this connection. Central computer 20 includes suitable memory and software and can be a standard purpose digital computer or server. Note that the statement that central computer 20 is “in communication with the auction units 10” does not mean that such communication needs to be continuous or at any specific time. The communication could be continuous. Alternatively, the communication could be intermittent, or even a one-time transmission of information from the auction units to the central computer before the live auction. Further, the auction units could be programmed not to communicate with central computer 10 unless they have a candidate for the live auction. The determination by an auction unit as to whether it has a candidate can be made the same way the way the central computer selects candidates, as described below.

Central computer 20 selects certain items from the silent auction phase for inclusion in the live auction. Many different criteria can be used to make the selection. For example, all items can be selected that had more than a predetermined number of bids during the silent auction phase, as this may indicate a high level of interest in those items. Alternatively, those items can be selected that had more than a predetermined number of bids during a predetermined period of time, such as a time period preceding the end of the silent auction. This may indicate that the item was getting significant “action” as the silent auction was closing, which again could be indicative of a high level of interest.

Further, the number of selected items can depend on the time available for the live auction. For example, if it is determined that the time available for the live auction would accommodate 20 items, then the 20 items from the silent auction that had the most action (e.g., defined as either the most bids or the most bids during a certain time interval) can be selected for the live auction. Alternatively, in similar circumstances the 20 items that had the highest bids can be selected for the live auction.

Once the candidates for the live auction are selected, the auctioneer proceeds to auction those items to the crowd in the traditional manner. The auctioneer may start the bidding at the highest bid recorded for the item during the silent auction phase, thereby potentially shortening the usual period of time required for the live auction of each item.

In an embodiment where the auction units are to make the determination as to what items are to be included in the live auction, the central computer can collect and transmit any necessary information to the auction units. For example, if an auction unit is programmed to make the decision based on whether a predetermined number of bids are received within a predetermined period of time, then the auction unit may not need information about bidding activity at other auction units to make this determination. However, if an auction unit is going to make the determination based on a plan to select the 20 most active items, then information on the bidding activity at other auction units regarding other items can be forwarded to all the auction units by the central computer.

As yet another alternative, the auction units can communicate to each other directly to share any necessary information. In fact, the central computer functions can be entirely performed by one or more of the auction units, rendering the central computer unnecessary. In such a case, the information as to which items to be included in the live auction can be communicated directly to the auctioneer by one or more of the auction units.

Note that, instead of having the potential bidders wander about the area where the auction units 10 are dispersed, the bidders could use a single auction unit to view all of the items. For example, each bidder (or group of bidders) could be assigned his or her own auction unit and can remain in one location (e.g., at a banquet table) and toggle through the items for sale. Since the auction units can be in communication with central computer 20 (either continuously or periodically, as noted above), the central computer can collect bid information as the silent auction progresses and send that information out to all auction units 10 such that each bidder can see any information the auction organizers choose to provide, e.g., the current high bid per item.

In one embodiment, the live auction is carried out by a person (auctioneer) who views information about the items selected for the live auction phase. In a different embodiment, the functions of such a human auctioneer are simulated by a computer program, either running on the central computer or on a different computer. Such a program would duplicate the steps that would be taken by a human auctioneer, e.g., to present items to the bidders, solicit bids and then close the auction on each item when certain conditions are met, such as when no more bids can be solicited.

Although the auction units 10 are described above as being generally dispersed in an auction area, it should be understood that some or all of the units could be at remote locations and the bidders can participate remotely. For example, the auction units can be individual personal computers, PDAs, cellular telephones, e-mail devices (e.g., Blackberry®) or the like connected to the central computer via the Internet or other means. Thus, the hybrid live and silent auction described above could be carried out over the Internet using a website, with the live auction component being similarly conducted using a website (with or without video feed of the auctioneer) to which the bidders are connected in the usual way.

Certain embodiments of the invention achieve distinct advantages over both traditional silent auctions and over traditional live auctions. Because those items that are garnering the most interest from the bidding crowd are generally selected for the silent auction phase, the final sales prices for those items will usually be higher than would be achieved through a silent auction. As for traditional live auctions, the hybrid system and method disclosed herein will avoid wasting time on items that are not going to garner a good level of interest from the particular crowd involved. One substantial limit on live auctions is the number of items that can be presented to the crowd. By effectively “screening” items in the silent auction phase, and by beginning the auction of items at a price higher than where the bidding would start in a typical live auction, the live auction time will be more productive.

Note that there are many variations that can be made to the embodiments described above and it should be understood that the foregoing description is for illustrative purposes only and is not intended to be limiting in any way. Rather, the invention should be limited only by the scope of the following claims, including all equivalents.

I claim:

1. A system for facilitating a hybrid live and silent auction for auctioning a plurality of items, comprising:
a plurality of interactive display devices dispersed throughout an area where an auction will take place during a first period of time, each of said interactive display devices being programmed to (i) display information concerning at least one of the plurality of items to be auctioned, (ii) to receive and store bid information input by a bidder related to the at least one item, (iii) to determine whether said at least one item will be included in a live auction to occur in a second period of time, the determination being based on said bid information; and (iii) to transmit information concerning said at least one item if said item is selected for inclusion in the live auction;
a central computer in communication with each of said interactive display devices and programmed to receive said information concerning said selected items from a plurality of said interactive display devices; and
a display coupled to said central computer, said central computer being further programmed to display said information concerning said selected items to an auctioneer to facilitate a live auction of said selected items during said second period of time.

2. A method for conducting a hybrid live and silent auction for auctioning a plurality of items, comprising the steps of:
presenting said items to potential bidders during a first period of time;
recording information concerning bids made on said items by the bidders during said first period of time;
selecting certain of said items for inclusion in a live auction to occur in a second period of time, said selecting being based on said information recorded during said recording step; and
presenting said items selected during said selecting step to the bidders in a live auction during said second period of time.

3. The method of claim 2 wherein said second period of time follows said first period of time.

4. The method of claim 2 wherein said second period of time at least partially overlaps said first period of time.

5. The method of claim 2 wherein said first period of time and said second period of time are concurrent.

6. The method of claim 2 wherein said presenting and recording steps are performed using a computer.

7. The method of claim 2 wherein those items that are not selected during said selecting step are deemed sold to a highest bidder recorded during said first period of time.

8. The method of claim 2 wherein said selecting step comprises selecting those items that have had at least a predetermined number of bids.

9. The method of claim 2 wherein said selecting step comprises selecting those items that have had at least a predetermined number of bids within a predetermined portion of said first period of time.

10. The method of claim 9 wherein said predetermined portion of said first period of time is at the end of said first period of time.

11. The method of claim 2 wherein said live auction begins for each selected item with the highest bid recorded during said first period of time.

12. A system for facilitating a hybrid live and silent auction for auctioning a plurality of items, comprising:
a plurality of interactive display devices dispersed throughout an area where an auction will take place during a first period of time, each of said interactive display devices being programmed to (i) display information concerning at least one of said plurality of items to be auctioned, (ii) to receive and store bid information input by a bidder related to said at least one item, and (iii) to transmit said bid information; and
a central computer in communication with each of said interactive display devices and programmed to receive bid information transmitted by each of said interactive display devices, said bid information representing bids concerning said plurality of items,
wherein said central computer is further programmed to select certain of said items for inclusion in a live auction to occur in a second period of time, said selecting being based on said bid information received from said interactive display devices.

13. The system of claim 12 wherein said second period of time follows said first period of time.

14. The system of claim 12 wherein said second period of time at least partially overlaps said first period of time.

15. The system of claim 12 wherein those items that are not selected during said selecting step are deemed sold to a highest bidder recorded during said first period of time.

16. The system of claim 12 wherein said computer is programmed to select those items that have had at least a predetermined number of bids.

17. The system of claim 12 wherein said computer is programmed to select those items that have had at least a predetermined number of bids within a predetermined portion of said first period of time.

18. The system of claim 17 wherein said predetermined portion of said first period of time is at the end of said first period of time.

19. The system of claim 12 wherein said central computer is further programmed to display information concerning said selected items to an auctioneer to facilitate a live auction of said selected items during said second period of time, said information including the highest bid recorded during said first period of time.

20. The system of claim 12 wherein said interactive display devices are each programmed to display information concerning a plurality of items to be auctioned.
